(19) United States
(12) Patent Application Publication
(10) Pub. No.: US 2004/0022240 A1
(43) Pub. Date: Feb. 5, 2004

(54) Minimum deflection routing in bufferless networks

(75) Inventors: Saad Mneimneh, Dallas, TX (US); Gerard Damm, Ottawa (CA); Dominique Verchere, Plano, TX (US); Franck Quessette, Versailles (FR)

Correspondence Address: ALCATEL USA, INTELLECTUAL PROPERTY DEPARTMENT, 3400 W. PLANO PARKWAY, MS LEGL2, PLANO, TX, 75075, US

(73) Assignee: Alcatel

(21) Appl. No.: 10/208,937

(22) Filed: Jul. 31, 2002

(51) Int. Cl. H04L 12/56

(52) U.S. Cl. 370/389; 370/386

(57) ABSTRACT

A bufferless network (e.g., optical burst network) and a method for executing a routing strategy that deflects a minimum number of packets in the bufferless network are described herein. The bufferless network includes a group of nodes (e.g., routers) and a set of links (e.g., paths) that connect together the nodes. Each node executes the routing strategy that deflects a minimum number of packets to unfavorable nodes instead of to favorable nodes that are closer to their final destination nodes. Three different embodiments of the routing strategy are described herein.

### BACKGROUND OF THE INVENTION

1. Field of the Invention

The present invention relates in general to bufferless networks and, in particular, to a bufferless network (e.g., optical burst network) that has a series of nodes in each of which there is a routing algorithm that deflects a minimum number of packets to unfavorable nodes instead of to favorable nodes that are closer to their final destination nodes.

2. Description of Related Art

In bufferless networks such as optical burst networks, the intermediate storage of packets in a node (e.g., router) is not possible because the nodes do not have buffers or storage units. As such, each node needs to execute a routing strategy wherein every time a node receives a set of packets in one time slot then that node must forward those packets to adjacent nodes at the next time slot. If this does not happen, then the node must drop one or more packets because it cannot store packets in a buffer or storage unit. Ideally, a packet is forwarded along a desired direction that is on a favorable link toward its final destination node. However, when two or more packets want to use the same link, the node cannot forward all of those packets directly towards their final destination node. Such packets are therefore deflected and routed on an unfavorable link to an unfavorable node away from their final destination node. A traditional routing strategy based on the augmenting path algorithm attempts to solve this deflection problem by trying to minimize the number of packets that are deflected and routed to unfavorable nodes away from their final destination node. However, traditional routing strategies based on the augmenting path algorithm are very complex and difficult to implement as can be appreciated by those skilled in the art. Accordingly, there is a need for abufferless network that executes a minimum deflection routing strategy which is not as complex and is easier to implement than the traditional algorithms.

### BRIEF DESCRIPTION OF THE INVENTION

The present invention includes a bufferless network (e.g., optical burst network) and a method for executing a routing strategy that deflects a minimum number of packets in the bufferless network. The bufferless network includes a group of nodes (e.g., routers) that are connected to one another by a set of links (e.g., paths). Each node executes the routing strategy that deflects a minimum number of packets to unfavorable nodes instead of to favorable nodes that are closer to their final destination nodes. Three different embodiments of the routing strategy are described herein.

### BRIEF DESCRIPTION OF THE DRAWINGS

A more complete understanding of the present invention may be obtained by reference to the following detailed description when taken in conjunction with the accompanying drawings wherein:

FIG. 1 is a diagram of a bufferless network incorporating a minimum deflection routing algorithm of the present invention;

FIG. 2 is a flowchart illustrating the steps of a preferred method for executing a first embodiment of the minimum deflection routing algorithm shown in FIG. 1;

FIGS. 3A-3E are graphs and tables showing five different examples of the execution of the method shown in FIG. 2;

FIG. 4 is a flowchart illustrating the steps of a preferred method for executing a second embodiment of the minimum deflection routing algorithm shown in FIG. 1;

FIGS. 5A-5E are graphs and tables showing five different examples of the execution of the method shown in FIG. 4;

FIG. 6 is a flowchart illustrating the steps of a preferred method for executing a third embodiment of the minimum deflection routing algorithm shown in FIG. 1; and

FIGS. 7A-7G are graphs and tables showing an example of the execution of the method shown in FIG. 6.

### DETAILED DESCRIPTION OF THE DRAWINGS

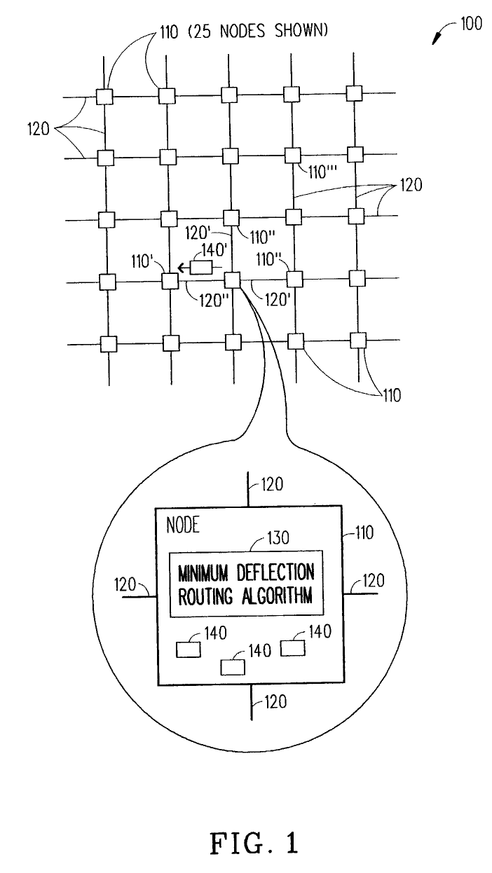

Referring to FIGS. 1-7, there are illustrated a bufferless network 100 (shown as an optical network) and preferred methods 200, 400 and 600 for executing a routing strategy in accordance with the present invention. Although the present invention is described below as being used in an optical network that has a grid-like topology, it should be understood that the present invention can be used in any type of bufferless network (e.g., radio network, wired network) that has any type of topology so long as a packet has at most two favorable links to two favorable nodes on which it would like to travel to get to its destination node. Accordingly, the bufferless network 100 and preferred methods 200, 400 and 600 should not be construed in such a limited manner.

As shown in FIG. 1, the bufferless network 100 includes a group of nodes 110 (e.g., routers) and a set of links 120 (e.g., paths) that connect together the nodes 110. Each node 110 executes a routing strategy 130 also described as a minimum deflection routing algorithm that deflects a minimum number of packets 140 (only one deflected packet 140′ is shown) to unfavorable nodes 110′ instead of favorable nodes 110″ that are closer to their destination nodes 110′″.

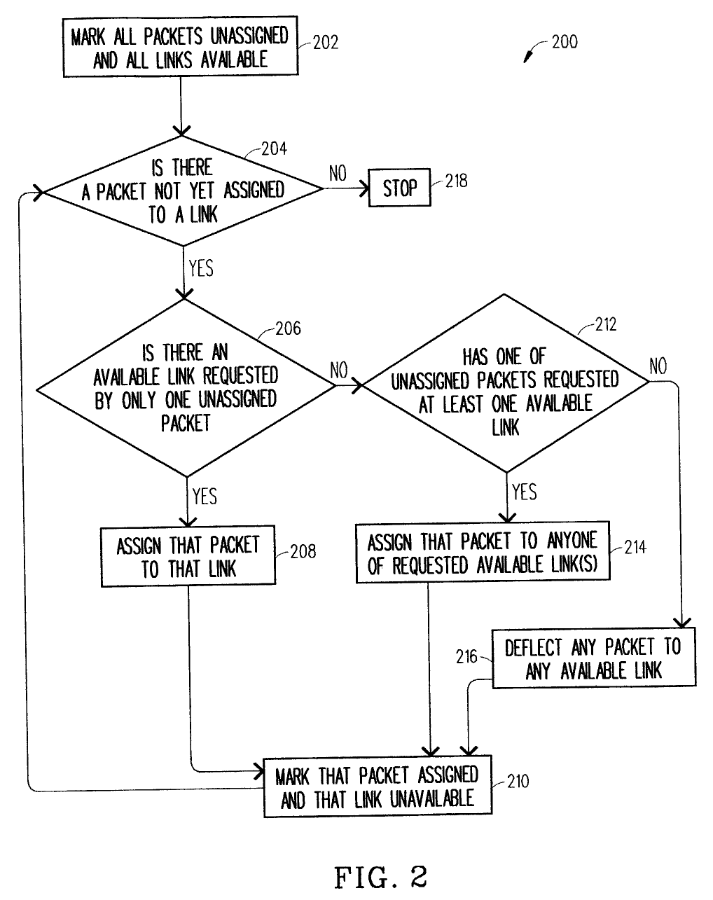

In particular, the bufferless network 100 can be a bufferless optical network such as a synchronous optical burst network (OBN) which has nodes 110 that do not have optical memories or buffers to store packets 140. The routing strategy 130 has a couple of requirements that need to be followed in order to deflect a minimum number of packets 140. First, the routing strategy 130 is a distributed algorithm and is applied independently at each time slot in each node 110. Secondly, each packet 140 has at most two favorable links 120 leading to two favorable nodes 110″ on which they would like to travel through to get to their final destination node 110′″. Three different embodiments of the routing strategy 130 are described below with respect to methods 200, 400 and 600 shown in FIGS. 2-7 after a brief description about bufferless networks 100 and how the routing strategy 130 can be modeled using a bipartite graph.

Again, in the bufferless network 100, the intermediate storage of packets 140 is not possible. Therefore, each node 110 in the bufferless network 100 receives a set of packets 140 requesting at most two different directions and executes a routing strategy by which it forwards all the packets 140 at the same time. Ideally, each packet 140 is forwarded along a desired direction that is on a favorable link 120 leading toward its final destination node 110′″. However, due to link 120 conflicts at the node 110, some packets 140 (only one deflected packet 140′ is shown) cannot be forwarded on a favorable link 120 (two favorable links 120′ are shown) directly towards their final destination node 110′″. Such packets 140 are therefore deflected and routed on an unfavorable link 120 (only one unfavorable link 120″ is shown) to an unfavorable node 110′ instead of to favorable nodes 110″ that are closer to their destination nodes 110′″.

The interest in a minimum deflection routing emanates from the need to deliver packets 140 as soon as possible to their final destination node 110′″. It is expected that by deflecting the minimum number of packets 140 at each node 110 in the bufferless network 100 there will be, as a result, a reduction of the average time by which a packet 140 is delivered to its final destination node 110′″. On the other hand, there is also an interest in linear complexity which emanates from the fact that the routing strategy 130 has to be performed efficiently and as fast as possible.

The minimum deflection routing algorithm is a routing strategy 130 by which every node 110 deflects the minimum possible number of packets 140. The problem of minimum deflection routing can be modeled at each node 110 as an assignment problem on a bipartite graph. In a bipartite graph BG=(V_{c}, V_{d}, E) where V_{c} represents a set of packets 140 (also known as customers), V_{d} represents a set of directions (also known as links 120), and E represents a set of requests, a routing is an assignment of packets 140 to links 120 (directions). A minimum deflection routing algorithm 130 is therefore an assignment in which the number of packets 140 that are deflected is minimized.

From hereinafter, the discussion associated with the minimum deflection routing strategy 130 is represented in the context of a bipartite graph. And, vertex in V_{c} of the bipartite graph has a degree of at most 2. Such a bipartite graph is represented as BG₂.

Definition 1: A bipartite graph BG=(V_{c}, V_{d}, E) is called a BG₂ graph if for every u ε V_{c}, deg(u)≦2.

In other terms, each packet 140 can request at most two links 120. This restriction on packets 140 emanates from the fact that in a 2-dimensional square grid network where the number of favorable links 120 from any node 110 to a final destination node 110′″ is at most 2. For instance, FIG. 1 illustrates a backbone of the bufferless network 100 in which there are at most two favorable links 120 (shown as links 120′) between any two nodes 110 (shown as the exploded nodes 110 and node 110′″). Nevertheless, if one looked at practical network topologies (e.g., US backbone network), they would find that this assumption is not a very restrictive one.

First Embodiment

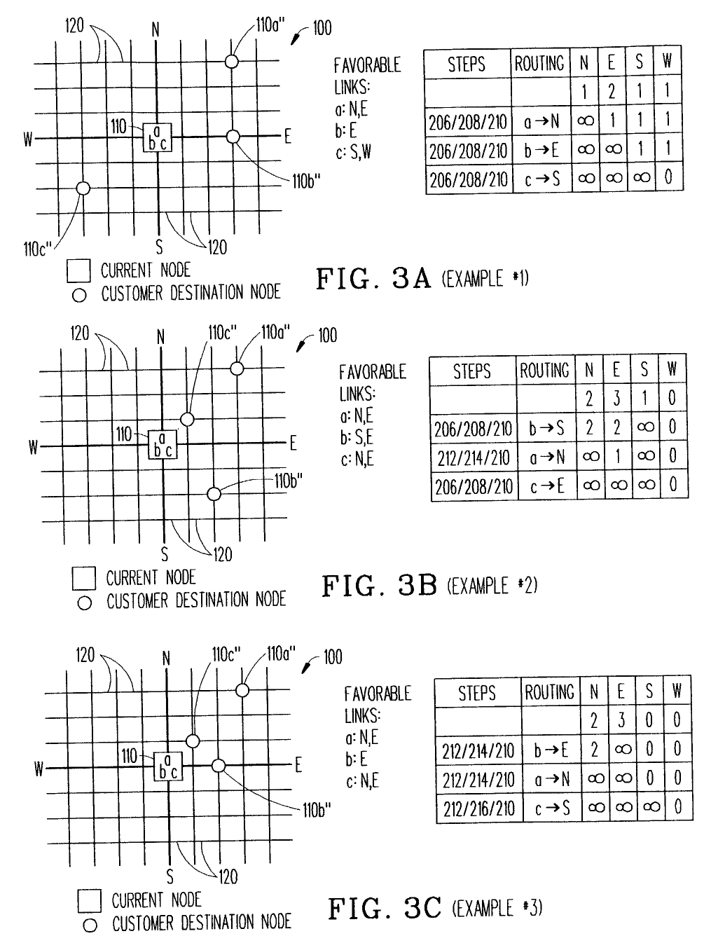

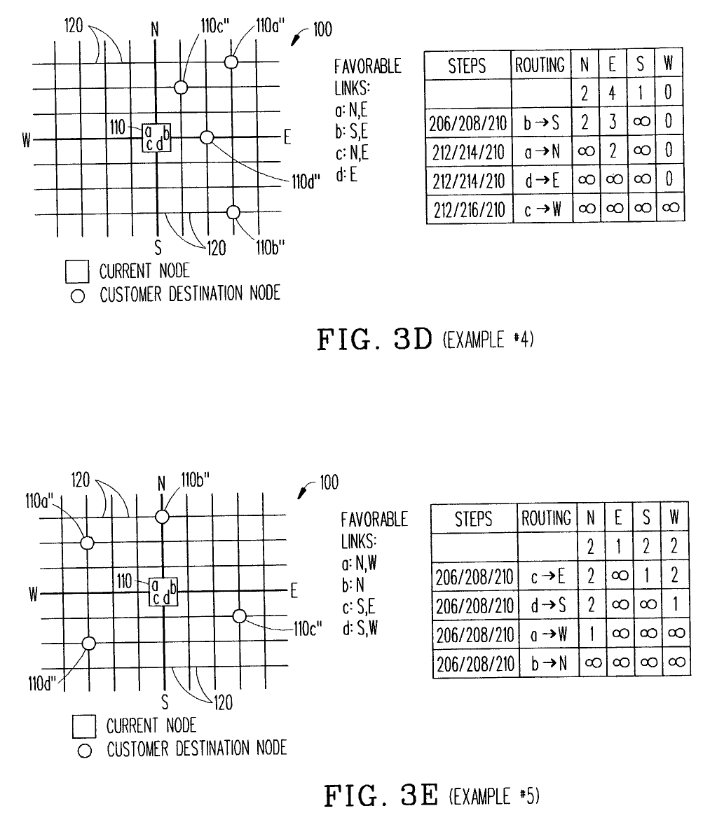

Referring to FIG. 2, there is a flowchart illustrating the steps of a preferred method 200 for executing the first embodiment of the minimum deflection routing algorithm 130a. To help better understand the different steps of the first embodiment of the minimum deflection routing algorithm 130a reference is made to five different examples in FIGS. 3A-3E.

Beginning at step 202, the minimum deflection routing algorithm 130a marks all packets 140 as unassigned packets 140 and all links 120 are marked as available links 120. In FIGS. 3A-3E, the packets 140 (shown as packets “a”, “b”, “c” and “d”) are located within node 110 (shown as current node 110) and want to get to their destination nodes 110″ (shown as destination nodes 110a″, 110b″, 110c″ and 110d″). The location of the destination nodes 110a″, 110b″, 110c″ and 110d″ indicate which links 120 are favorable links 120 for the respective packets 140a, 140b, 140c and 140d. In example #4 shown in FIG. 3D, the favorable links 120 (shown as directions N, S, E and W) for each packet 140a, 140b, 140c and 140d are as follows:

packet 140a: N and E.

packet 140b: S and E.

packet 140c: N and E.

packet 140d: E.

At step 204, the minimum deflection routing algorithm 130a determines if there is a packet 140 not yet assigned to a link 120. If the answer to step 204 is no, then at step 218 the minimum deflection routing algorithm 130a is stopped.

Referring to example #4 in FIG. 3D, for the first time through step 204 none of the packets 140a, 140b, 140c or 140d are assigned to a link 120 (goto step 206). For the second time through step 204, packets 140a, 140c and 140d are not assigned to a link 120 (goto step 206). For the third time through step 204, packets 140c and 140d are not assigned to a link 120 (goto step 206). For the fourth time through step 204, packet 140c is not assigned to a link 120 (goto step 206). For the fifth time through step 204, all the packets 140a, 140b, 140c and 140d have all been assigned so the minimum deflection routing algorithm 130a stops.

If the answer to step 204 is yes, then at step 206 the minimum deflection routing algorithm 130a determines if there is an available link 120 that is requested by only one unassigned packets 140.

Referring to example #4 in FIG. 3D, for the first time through step 206 there is an available link 120 (shown as direction S) that is requested by one unassigned packet 140b (goto step 208). For the second, third and fourth times through step 206 there is not an available link 120 that is requested by only one unassigned packet 140a, 140c or 140d and as such the method 200 proceeds to step 212.

If the answer to step 206 is yes, then at step 208 the minimum deflection routing algorithm 130a assigns that unassigned packet 140 to that available link 120. Then at step 210, the minimum deflection routing algorithm 130a marks that packet 140 as assigned and marks that link 120 as unavailable. The minimum deflection routing algorithm 130a then returns to the first determining step 204.

Referring to example #4 in FIG. 3D, for the first time through step 208, the packet 140b is assigned to the only one available link 120 (shown as direction S) and that link 120 is marked as unavailable. In this example, step 208 is performed only once for packet 140b.

If the answer to step 206 is no, then at step 212 the minimum deflection routing algorithm 130a determines if an unassigned packet 140 has a request for one or more available links 120.

Referring to example #4 in FIG. 3D, for the first time through step 212, packet 140a has two requests for available links 120 (directions N and E) (goto step 214). For the second time through step 212, packet 140d has a request for an available link 120 (directions E) (goto step 214).

If the answer to step 212 is yes, then at step 214 the minimum deflection routing algorithm 130a arbitrarily assigns that packet 140 to anyone of available links 120. Then at step 210, the minimum deflection routing algorithm 130a marks that packet 140 as assigned and marks that link 120 as unavailable. The minimum deflection routing algorithm 130a then returns to the first determining step 204.

Referring to example #4 in FIG. 3D, for the first time through step 214, the packet 140a is arbitrarily assigned to one of the available links 120 (shown as directions N and E) and that link 120 (direction N) is marked as unavailable (goto step 204). For the second time through step 214, the packet 140d is arbitrarily assigned to the available link 120 (shown as direction E) and that link 120 (direction E) is marked as unavailable (goto step 204). If the answer to step 212 is no, then at step 216 the minimum deflection routing algorithm 130a deflects and assigns that packet 140 to any link 120 that is currently available even though that link 120 was not requested by that packet 140. Then at step 210, the minimum deflection routing algorithm 130a marks that packet 140 as assigned and marks that link 120 as unavailable. The minimum deflection routing algorithm 130a then returns to the first determining step 204.

Referring to example #4 in FIG. 3D, for the first time through step 216, the packet 140c which had requested links 120 (directions N and E) that have been assigned to other packets 140a and 140d has been deflected to an available link 120 (direction W) and that link 120 (direction W) is marked as unavailable (goto step 204).

The remaining examples #1-3 and #5 shown in FIGS. 3A-3C and 3E are provided to help one better understand the different steps of the first embodiment of the minimum deflection routing algorithm 130a. It should be understood that there are many different ways one could implement the first embodiment of the minimum deflection routing algorithm 130a to obtain the same results.

Below is another way to describe the first embodiment of the minimum deflection routing algorithm 130a using terminology associated with a non-weighted bipartite graph. Again, BG=(V_{c}, V_{d}, E) is the bipartite graph representing the packets 140 and directions 120. The minimum deflection routing algorithm 130a that computes a routing R can be represented as:

```
R = φ
while E ≠ φ
    if ∃ (u,v) ∈ E with deg(v) = 1
        R=R ∪ {(u,v)}
    else
        pick any (u,v) ∈ E
        R=R ∪ {(u,v)}
```

remove all edges in E that are adjacent to vertices u or v, where u is a packet and v is a direction.

In simple terms, the minimum deflection routing algorithm 130a starts with the BG graph and updates it, by removing edges, after each assignment it makes until no more assignments are possible. Whenever there is a link (direction) that is requested only once in the updated BG, it assigns to this link its only packet. Otherwise, it makes an arbitrary assignment. It should be noted that this representation of the minimum deflection routing algorithm 130a does not mention the actual deflection of packets, but the packets that can not be assigned to a favorable link are deflected the same as steps 216 and 210 in method 200.

As an example, consider the 2-dimensional square grid bufferless network 100 shown in FIG. 3D. In this example, there are four packets a, b, c, and d; and four directions N, S, E, and W. Packets a and c have both two desired directions N and E. Packet d has only one desired direction E. Packet b has two desired directions S and E.

The minimum deflection routing algorithm 130a proceeds as follows for example #4 shown in FIG. 3D. Since the direction S is requested only once, it will be assigned its packet b. The minimum deflection routing algorithm 130a will remove edges (b, S) and (b, E). We are left with three packets a, c, and d; and directions N, W and E. Since there are no more directions that are requested only once, the minimum deflection routing algorithm 130a will pick an arbitrary assignment. Let's assume that it assigns packet a to direction N and removes edges (a, N), (a, E), and (c, N). Finally, one is left with two packets c and d, and directions E and W. Again, the minimum deflection routing algorithm 130a will pick an arbitrary assignment, say it assigns packet d to direction E and removes edges (d, E) and (c, E). There are no more edges in the graph and hence the minimum deflection routing algorithm 130a stops. There is only one deflected packet, namely, packet c. In a bi-directional network, it is assumed that the number of packets that arrive at a node is at most the number of available directions. Therefore, there is always enough directions to forward all packets. In this example, packet c will be deflected to direction W.

Below is a proof of the correctness of the minimum deflection routing algorithm 130a. The routing strategy 130a as presented above computes a minimum deflection routing if BG is a BG₂ graph. The proof relies on the fact that the minimum reflection routing algorithm 130a computes a maximum cardinality matching in a BG₂ graph. Start with a simple lemma.

Lemma 1A: If a graph G contains a vertex v with degree 1, then there exists a maximum cardinality matching that contains the edge (u, v) that connects v in G.

Proof: Consider a maximum cardinality matching M that does not contain (u, v). Unmatching u and adding (u, v) to M will result in a maximum cardinality matching M′ that contains (u, v).

Note that Lemma 1A justifies the steps 206 and 208 of the minimum deflection routing algorithm 130a where a direction with degree 1 is assigned first.

Lemma 2A: Given a BG₂=(V_{c}, V_{d}, E) where every node v ε V_{d} has deg(v)≧2, let (u, v) be any edge in E. Then there exists a maximum cardinality matching M that contains (u, v).

Proof: Let M be a maximum cardinality matching that does not contain (u, v). If either u or v is not matched in M, then we can unmatch either u or v in M and add (u, v) to M without having to unmatch any additional vertex. Thus, one can obtain a maximum cardinality matching M′ that contains (u, v). So assume that both u and v are matched in M. Let u be matched to v₀ and v be matched to u₀. Consider an alternating path starting with u₀, v, u, v₀, . . . The alternating path will remove (u₀, v), add (u, v), remove (u, v₀), etc . . . Since each vertex in V_{d} has degree at least 2, whenever one reaches a vertex in V_{d} they can find an edge that takes them back to V_{c}. Note that one always reaches a vertex in V_{c} from an edge that is not in the matching M. So whenever one reaches a vertex in V_{c} that is matched in M, they can continue on the path along the edge that matches that vertex in M to a new vertex in V_{d}. Therefore, one can continue the alternating path by adding and removing edges as described above until they either reach a node in V_{c} that is not matched in M or reached node u₀. In both cases, one obtains a matching M′ that contains (u, v) and has the same cardinality as M.

Using Lemma 1A and Lemma 2A, one can prove the following result.

Theorem 1A: minimum deflection routing algorithm 130a computes a minimum deflection routing in a BG₂ graph.

Proof: It is equivalent to prove that minimum deflection routing algorithm 130a computes a maximum cardinality matching in a BG₂ graph. From Lemma 1A and Lemma 2A, the minimum deflection routing algorithm 130a always picks an edge that can be part of the maximum cardinality matching in the updated BG₂ graph. Therefore, the minimum deflection routing algorithm 130a computes a maximum cardinality matching.

It has been proved that the minimum deflection routing algorithm 130a computes a minimum deflection routing in a BG₂ graph. However, one can further quantify that minimum as stated in the following lemma. Let d_{R} be the number of deflections with a routing R. Let

dmin=min R dR

be the minimum deflection possible with any routing R.

Lemma 3A: For a BG₂ graph with k connected components G₁=(V_{c1}, V_{d1}, E₁), . . . , Gₖ=(V_{ck}, V_{dk}, Eₖ),

$${d}_{min} = {min}_{R} {d}_{R}$$

where x⁺ is defined as max(0, x).

$${d}_{min} = {\sum }_{i = 1}^{k} {( \vert {V}_{{c}_{i}} \vert - \vert {V}_{{d}_{i}} \vert )}^{+}$$

Proof: Consider one connected component Gᵢ. It can be proved that the size of a vertex cover for Gi is at least min(|V_{ci}|, |V_{di}|). This implies that the minimum size vertex cover is at least min(|V_{ci}|, |V_{di}|). By Konig's theorem, the cardinality of the maximum matching is equal to the size of the minimum vertex cover in a bipartite graph. Since, the minimum deflection routing algorithm 130a computes a minimum deflection routing, it computes a maximum cardinality matching in Gᵢ which will be at least min(|V_{ci}|, |V_{di}|). But the maximum cardinality matching in Gᵢ cannot be greater than min(|V_{ci}|, |V_{di}|), so it is exactly equal to min(|V_{ci}|, |V_{di}|). Therefore the number of deflections in Gᵢ is equal to (|V_{ci}|−|V_{di}|)⁺. Summing over all the connected components one gets the result above. To prove that a vertex cover for Gᵢ has size at least min(|V_{ci}|, |V_{di}|). Recall that Gᵢ is a connected BG₂ graph. Consider a vertex cover C for Gᵢ. Let S₁ be the set of all vertices in V_{di} that are in C. If S₁ is empty, then C must contain all vertices in V_{ci}. So assume that S₁ is not empty. Let S₂ be the set of nodes in V_{ci} that are connected to two vertices in V_{di} such that one of them is in S₁ and the other is not in S₁. If S₂ is empty, then |V_{di}|=|S₁| and one is done; because otherwise, Gᵢ will be disconnected. Let S₃ be the set of vertices in V_{di} that are not in S₁ but connected to a vertex in S₂. Note that |S₂|=|S₃|. Since none of the vertices of S₃ is in C by definition of S₁, all vertices in S₂ must be in C. Let S₄ be the set of vertices in V_{di} that are not in S₁ nor in S₃. Without loss of generality, assume S₄ is not empty. One knows that vertices in S₄ are not in C by definition of S₁. Since Gi is connected, the only way for each vertex v in S₄ to be connected to the rest of the graph is by an edge going to a vertex u in V_{ci} that is in C and that is in turn connected to S₃. Let the set of these u vertices be S₅. Since each vertex in V_{ci} has degree at most 2, |S₅|=|S₄|. As a result |C|≧|S₁|+|S₂|+|S₅|=|S₁|+|S₃|+|S₄|=|V_{d1}|.

It should be understood that the minimum deflection routing algorithm 130a has a linear time complexity in the RAM model as stated in the following theorem:

Theorem 2A: The time complexity of Algorithm I on a BG2 graph is O(|V_{c}|) in the RAM model.

Proof: In each step of the minimum deflection routing algorithm 130a, at least one edge is removed from the graph. Looking for directions with degree 1 can be done is a constant time by maintaining a list of directions that have degree 1 and updating that list whenever some edges are removed. If each edge keeps a pointer to its vertex in V_{d}, the work spent on updating the list in each step is proportional to the number of edges removed during that step. Since the number of edges is at most 2|V_{c}|, the minimum deflection routing algorithm 130a has a linear time complexity in the number of packets.

Second Embodiment

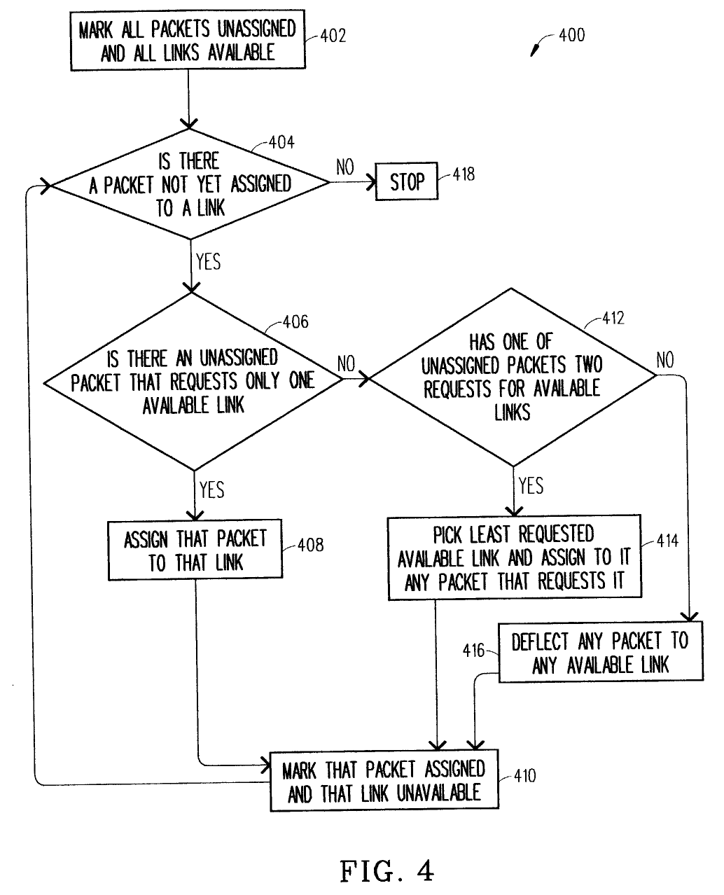

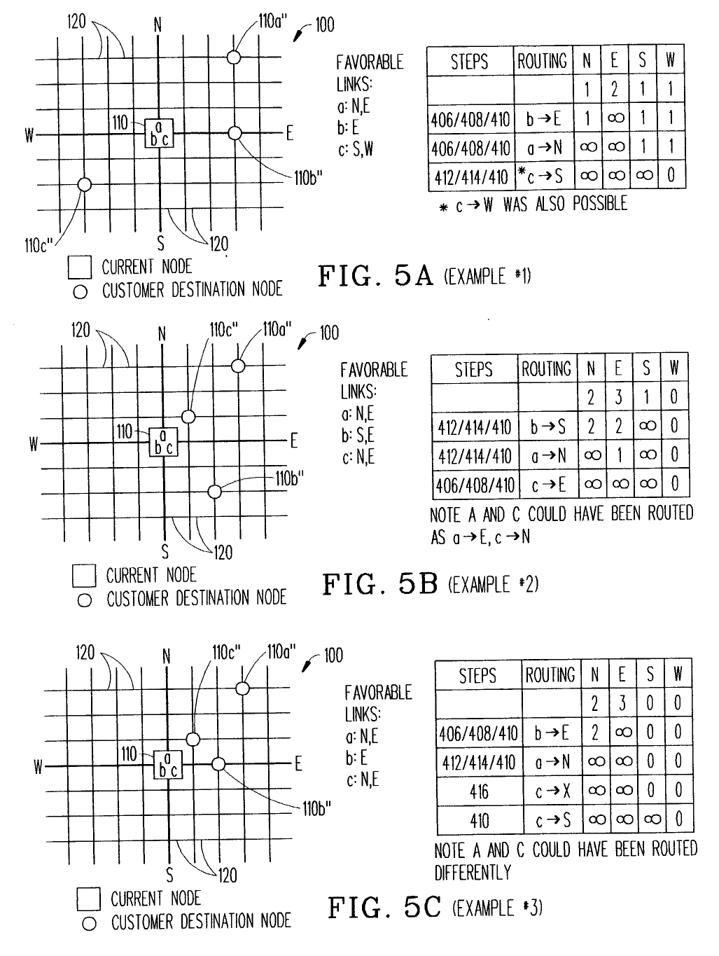

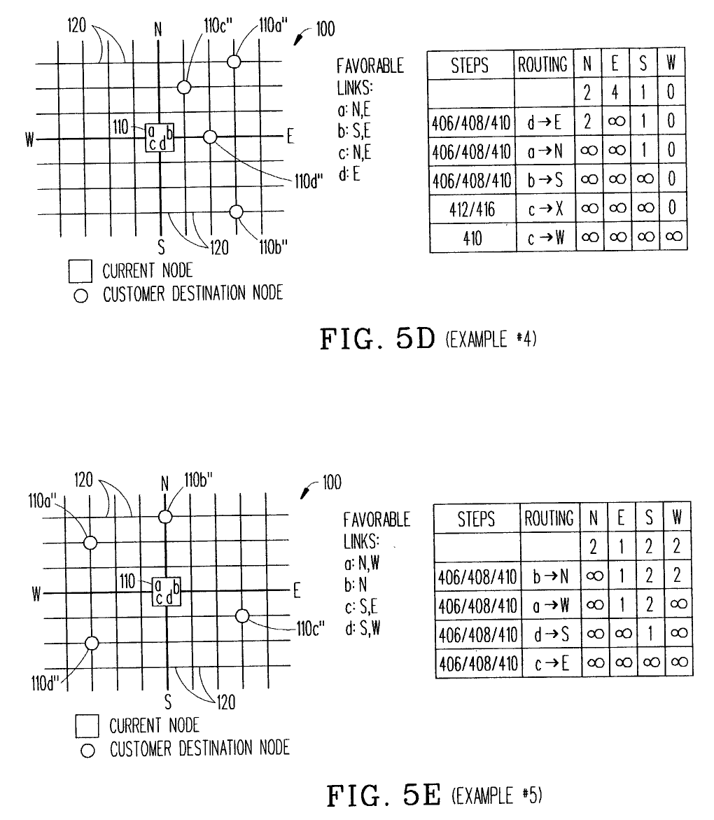

Referring to FIG. 4, there is a flowchart illustrating the steps of a preferred method 400 for executing the second embodiment of the minimum deflection routing algorithm 130b. To help better understand the different steps of the second embodiment of the minimum deflection routing algorithm 130b reference is made to five different examples in FIGS. 5A-5E.

Beginning at step 402, the minimum deflection routing algorithm 130a marks all packets 140 as unassigned packets 140 and all links 120 are marked as available links 120. In FIGS. 5A-5E, the packets 140 (shown as packets “a”, “b”, “c” and “d”) are located within node 110 (shown as current node 110) and want to get to their destination nodes 110″ (shown as destination nodes 110a″, 110b″, 110c″ and 110d″). The location of the destination nodes 110a″, 110b″, 110c″ and 110d″ indicate which links 120 are favorable links 120 for the respective packets 140a, 140b, 140c and 140d. In example #4 shown in FIG. 5D, the favorable links 120 (shown as directions N, S, E and W) for each packet 140a, 140b, 140c and 140d are as follows:

packet 140a: N and E.

packet 140b: S and E.

packet 140c: N and E.

packet 140d: E.

At step 404, the minimum deflection routing algorithm 130a determines if there is a packet 140 not yet assigned to a link 120. If the answer to step 404 is no, then at step 418 the minimum deflection routing algorithm 130b is stopped.

Referring to example #4 in FIG. 5D, for the first time through step 404 none of the packets 140a, 140b, 140c or 140d are assigned to a link 120 (goto step 406). For the second time through step 404, packets 140a, 140b and 140c are not assigned to a link 120 (goto step 406). For the third time through step 404, packets 140c and 140b are not assigned to a link 120 (goto step 406). For the fourth time through step 404, packet 140c is not assigned to a link 120 (goto step 406). For the fifth time through step 404, all the packets 140a, 140b, 140c and 140d have all been assigned so the minimum deflection routing algorithm 130a stops.

If the answer to step 404 is yes, then at step 406 the minimum deflection routing algorithm 130b determines if one of the unassigned packets 140 requested only one available link 120.

Referring to example #4 in FIG. 5D, for the first time through step 406 there is one unassigned packet 140d that requested only one available link 120 (shown as direction E) (goto step 408). For the second time through step 406, each of the packets 140a, 140b and 140c had requested only one available link 120 (since direction E is no longer available). For the third time through step 406, packet 140b had requested only one available link 120 (direction S since requested direction E is no longer available). For the fourth time through step 406, since packet 140c does not have a request for an available link 120 then the method proceeds to step 416. It should be understood that at step 406 if several packets are requesting only one available link 120, then one of these packets is selected arbitrarily.

If the answer to step 406 is yes, then at step 408 the minimum deflection routing algorithm 130a assigns that unassigned packet 140 to that available link 120. Then at step 410, the minimum deflection routing algorithm 130b marks that packet 140 as assigned and marks that link 120 as unavailable. The minimum deflection routing algorithm 130a then returns to the first determining step 404.

Referring to example #4 in FIG. 5D, for the first time through step 408, the packet 140d is assigned to the uniquely requested one available link 120 (shown as direction E) and that link 120 is marked as unavailable (goto step 404). For the second time through step 408, the packet 140a is assigned to the uniquely requested one available link 120 (shown as direction N) and that link 120 is marked as unavailable (goto step 404). For the third time through step 408, the packet 140b is assigned to the uniquely requested one available link 120 (shown as direction S) and that link 120 is marked as unavailable (goto step 404).

If the answer to step 406 is no, then at step 412 the minimum deflection routing algorithm 130b determines if one of the unassigned packets 140 has two requests for available links 120.

Referring to example #4 in FIG. 5D, at this time none of the packets have two requests for available links 120.

If the answer to step 412 is yes, then at step 414 the minimum deflection routing algorithm 130b picks one of the available links 120 requested the least by all of the unassigned packets and assigns that packet 140 to that link 120. Again, it should be understood at step 414 that if several packets are requesting only one available link 120, then one of these packets is selected arbitrarily. Then at step 410, the minimum deflection routing algorithm 130b marks that packet 140 as assigned and marks that link 120 as unavailable. The minimum deflection routing algorithm 130b then returns to the first determining step 404.

Referring to example #4 in FIG. 5D, at this time none of the unassigned packets have two requests for available links 120.

If the answer to step 412 is no, then at step 416 the minimum deflection routing algorithm 130a deflects and assigns any unassigned packet 140 to any link 120 that is currently available even though that link 120 was not requested by that packet 140. Then at step 410, the minimum deflection routing algorithm 130a marks that packet 140 as assigned and marks that link 120 as unavailable. The minimum deflection routing algorithm 130a then returns to the first determining step 404.

Referring to example #4 in FIG. 5D, for the first time through step 416, the packet 140c which had requested links 120 (directions N and E) that have been assigned to other packets 140a and 140d has been deflected to an available link 120 (direction W) and that link 120 (direction W) is marked as unavailable (goto step 404).

The remaining examples #1-3 and #5 shown in FIGS. 5A-5C and 5E are provided to help one better understand the different steps of the second embodiment of the minimum deflection routing algorithm 130b. It should be understood that there are many different ways one could implement the second embodiment of the minimum deflection routing algorithm 130b to obtain the same results.

Below is another way to describe the second embodiment of the minimum deflection routing algorithm 130a using terminology associated with a non-weighted bipartite graph. Again, BG=(V_{c}, V_{d}, E) is the bipartite graph representing the packets 140 and directions 120. The minimum deflection routing algorithm 130b that computes a routing R can be represented as:

```
R = φ
while E ≠ φ
    if ∃ (u,v) ∈ E with deg(u) = 1
        R=R ∪ {(u,v)} [PART A]
    else
        pick any (u,v) ∈ E such that deg(v) is minimum
        R=R ∪ {(u,v)} [PART B]
```

remove all edges in E that are adjacent to vertices u or v, where u is a packet and v is a direction.

Like above, it should be noted that this representation of the minimum deflection routing algorithm 130b does not mention the actual deflection of packets, but the packets that can not be assigned to a favorable link are deflected the same as steps 416 and 410 in method 400.

The minimum deflection routing for algorithm 130b which is composed of two parts A and B has a similar proof as algorithm 130a where part A is based on Lemma 1A in algorithm 130a and part B is just a specific implementation of algorithm 130a.

Third Embodiment

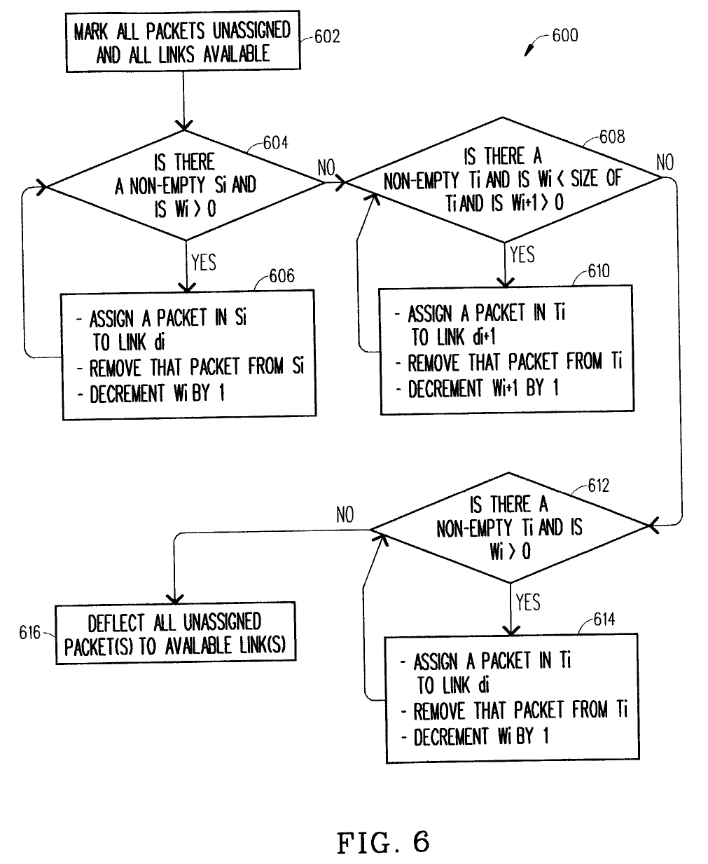

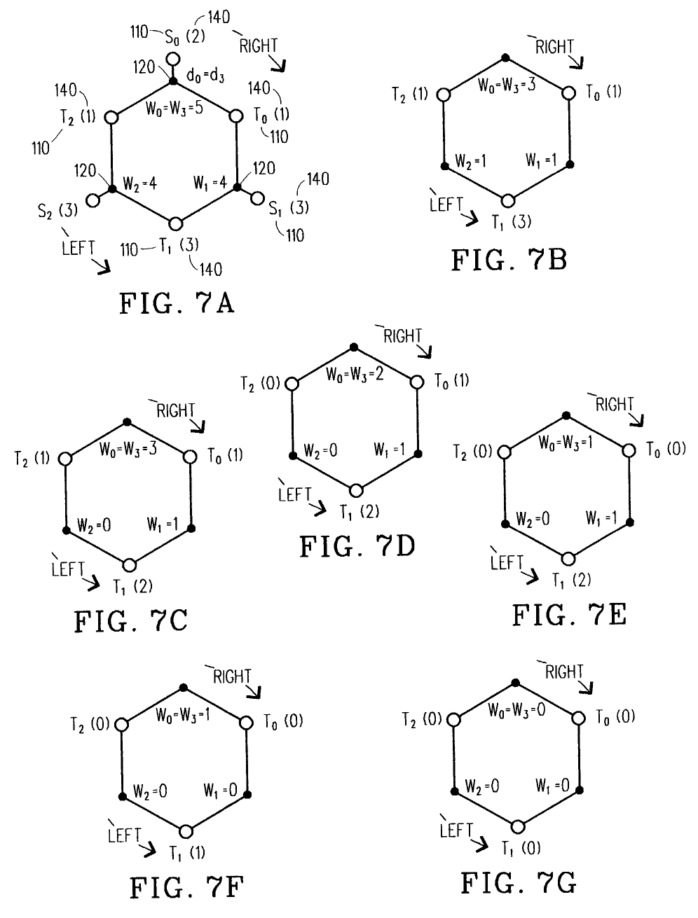

Referring to FIG. 6, there is a flowchart illustrating the steps of a preferred method 600 for executing the third embodiment of the minimum deflection routing algorithm 130c. Algorithm 130c is similar to algorithms 130a and 130b, except that algorithm 130c is associated with a packet that requests at most 2 contiguous directions. To help better understand the different steps of the third embodiment of the minimum deflection routing algorithm 130c reference is made to the example shown in FIGS. 7A-7G.

First, the minimum deflection routing algorithm 130c has the following defined parameters:

Each packet 140 requests at most 2 contiguous directions.

Sᵢ is the set of packets 140 requesting only one link (dᵢ).

Tᵢ is the set of packets 140 requesting two contiguous links (dᵢ and dᵢ₊₁).

wᵢ is the weight of link (dᵢ).

Referring to the example shown in FIG. 7A, there is shown an adjacent BG₂ graph with a number of packets 140 that are going to be assigned to a link 120 using the minimum deflection routing algorithm 130c.

Beginning at step 602, the minimum deflection routing algorithm 130c marks all packets 140 as unassigned packets 140 and all links 120 are marked as available links 120.

At step 604, the minimum deflection routing algorithm 130c determines if there is a non-empty Sᵢ and if wᵢ>0. If the answer to step 604 is yes, then at step 606 the minimum deflection routing algorithm 130c assigns a packet 140 in Sᵢ to link dᵢ, removes that packet 140 from Sᵢ, decrements wᵢ by one and returns to the first determining step 604. Steps 604 and 606 are also known as the first stage (degree 1 assign) of the minimum deflection routing algorithm 130c.

Referring to the example shown in FIG. 7B, at this time all of the packets 140 in Sᵢ are assigned to link dᵢ so long as wᵢ>0 (compare this BG₂ graph to the BG₂ shown in FIG. 7A).

If the answer to step 604 is no, then at step 608 the minimum deflection routing algorithm 130c determines if there is a non-empty Tᵢ and if wᵢ is less than a size of Tᵢ and wᵢ₊₁>0. If the answer to step 608 is yes, then at step 610 the minimum deflection routing algorithm 130c assigns a packet 140 in Tᵢ to link dᵢ₊₁, removes that packet 140 from Tᵢ, decrements wᵢ₊₁ by one and returns to the second determining step 608. Steps 608 and 610 are also known as the second stage (right assign) of the minimum deflection routing algorithm 130c.

Referring to the example shown in FIG. 7C, during the first time through steps 608 and 610 where |T₁|>w₁ and w₂>0 then the minimum deflection routing algorithm 130c assigns one packet 140 in T₁ to link d₂ (compare this BG₂ graph to the BG₂ shown in FIG. 7B) Referring to FIG. 7D, for the second time through steps 608 and 610 where |T₂|>w₂ and w₃=w₀>0 then the minimum deflection routing algorithm 130c assigns one packet 140 in T₂ to link d₃ (compare this BG₂ graph to the BG₂ shown in FIG. 7C).

If the answer to step 608 is no, then at step 612 the minimum deflection routing algorithm 130c determines if there is a non-empty Tᵢ and if wᵢ>0. If the answer to step 612 is yes, then at step 614 the minimum deflection routing algorithm 130c assigns a packet 140 in Tᵢ to link dᵢ, removes that packet 140 from Tᵢ, decrements wᵢ by one and returns to the third determining step 612. Steps 612 and 614 are also known as the third stage (left assign) of the minimum deflection routing algorithm 130c.

Referring to the example shown in FIG. 7E, during the first time through steps 608 and 610 where T₀ is not empty and w₀>0 then the minimum deflection routing algorithm 130c assigns one packet 140 in T₀ to link d₀ (compare this BG₂ graph to the BG₂ shown in FIG. 7D). Referring to FIG. 7F, for the second time through steps 612 and 614 where T₁ is not empty and w₁>0 then the minimum deflection routing algorithm 130c assigns one packet 140 in T₁ to link d₁ (compare this BG₂ graph to the BG₂ shown in FIG. 7E).

If the answer to step 612 is yes, then at step 616 the minimum deflection routing algorithm 130c deflects and assigns all remaining unassigned packets 140 to remaining unassigned links 120. After this the minimum deflection routing algorithm 130c is stopped.

Referring to the example shown in FIG. 7G, during the first time through step 616 where an unassigned packet 140 in T₁ is assigned to link dₒ (compare this BG₂ graph to the BG₂ shown in FIG. 7F).

Below is another way to describe the third embodiment of the minimum deflection routing algorithm 130c using terminology associated with a bipartite graph with weights on V_{d}. For a graph BG=(V_{c}, V_{d}, E), assume that each direction in V_{d} has a weight w and can accommodate up to w packets instead of only one. Also, assume that the weighted graph satisfies the following adjacency property.

Definition 1C: A graph BG=(V_{c}, V_{d}, E) is said to be adjacent if there exist a circular ordering of the directions <d₀, d₁, d₂, . . . , d_{|vd|-1}, d₀>, such that each packet is requesting a contiguous subset of directions in V_{d}.

As an example, in the square grid network one can order the directions as follows:

<North, East, South, West, North>

Each packet 140 requests a contiguous subset of these links 120 on its favorable (i.e. shortest) path to its final destination node 110′″. The possibilities are: N, E, W, S, NE, SE, NW, and SW.

In general, most of the practical network topologies when presented with a set of requests result in an adjacent BG₂ graph at every node 110. Therefore, adjacent BG₂ graphs are used (see FIG. 7A). Note that in an adjacent BG₂ graph, a packet 140 can request only dᵢ and dᵢ₊₁ for some i=0 . . . |V_{d|}, where V_{|vd}|=V₀. For convenience, the inventors use a different representation of the adjacent BG₂ graph. Let d₀, d₁, . . . , d_{|vd|} represent the ordered directions. Let wᵢ for i=0 . . . . . . |V_{d}| be the weight of direction dᵢ. Let Sᵢ for i=0 . . . |V_{d}|−1 represent the set of packets 140 that are requesting direction dᵢ only. Let Tᵢ for i=0 . . . |V_{d}|−1 be the set of packets 140 that are requesting directions dᵢ and dᵢ₊₁. This representation is shown in FIG. 7 for |V_{d}|=3 (but other directions are possible).

It should be understood that a representation similar to that of FIG. 7 can be obtained for any adjacent BG₂ graph with any number of directions |V_{d}|. Note the Right and Left conventions illustrated in FIG. 7.

The minimum deflection routing algorithm 130c has three stages. In the first stage, the routing strategy 130c makes assignments from the sets Sᵢ (see steps 604 and 606). In the second stage, the routing strategy 130c makes assignments from the sets Tᵢ to the right (see steps 608 and 610). In the third stage, the routing strategy 130c makes assignments from the sets Tᵢ to the left (see steps 612 and 614).

where:

Each packet requests at most 2 contiguous directions;

Sᵢ is the set of packets requesting only one link (dᵢ);

Tᵢ is the set of packets requesting two contiguous links (dᵢ and dᵢ₊₁); and

wᵢ is the weight of link (dᵢ);

R=φ

while ∃i such that Sᵢ≠φ and wᵢ>0 (degree 1 assign) pick any packet c ε Sᵢ

Sᵢ=Sᵢ−{c}

wᵢ=wᵢ−1

R=R∪{(c,dᵢ)}

while ∃i such that |Tᵢ|>wᵢ and wᵢ₊₁>0 (right assign) pick any packet c ε Tᵢ

Tᵢ=Tᵢ−{c}

wᵢ₊₁=wᵢ₊₁−1

R=R∪{(c,dᵢ₊₁)}

while ∃i such that Tᵢ≠φ and wᵢ>0 (left assign) pick any packet c ε Tᵢ

Tᵢ=Tᵢ−{c}

wᵢ=wᵢ−1

R=R∪{(c,dᵢ)}

By the symmetry of the minimum deflection routing algorithm 130c, the Right and Left conventions of FIG. 7 can be reversed. Not only that, but it is also possible for the minimum deflection routing algorithm 130c to reverse the Right and Left conventions at any time during its operation. This might be useful in practice as the following argument illustrates. The first and third stages are straight-forward because they basically entail assigning, for i=0 . . . |V_{d}|−1, as many packets 140 as possible from Sᵢ to dᵢ and from Tᵢ to the Left respectively. Therefore, the conditions of the first and third stages do not need to be checked explicitly. If by reversing the Right and Left conventions, the condition for the second stage becomes unsatisfied, the minimum deflection routing algorithm 130c can go directly to the third stage and reduce the number of times the condition in the second stage needs to be checked.

Below the inventors prove that the minimum deflection routing algorithm 130c computes a minimum deflection routing.

First, the inventors state and prove a simple lemma similar to Lemma 1A in the first embodiment of the minimum deflection routing algorithm 130a.

Lemma 1C: In an adjacent weighted BG₂ graph, if Sᵢ≠0 and wᵢ>0, there exists a minimum deflection routing that assigns a packet 140 in Sᵢ to direction dᵢ.

Proof: Consider a minimum deflection routing R that does not assign a packet in Sᵢ to dᵢ. This implies that all the packets in Sᵢ are deflected in R since they all request dᵢ only. Let c be an arbitrary packet in Sᵢ. Assign c to dᵢ and deflect one packet that is already assigned to dᵢ in R, thus not exceeding the weight wᵢ. One obtains a minimum deflection routing R′ that assigns a packet in Sᵢ to dᵢ.

Lemma 1C justifies the first stage of the minimum deflection routing algorithm 130c. Note that after the first stage is done wᵢ>0 and Sᵢ=0. Next the inventors prove another lemma that shows that the work done in the second stage does not violate the minimum deflection routing.

Lemma 2C: In an adjacent weighted BG₂ graph, if |Tᵢ|>wᵢ and if wᵢ₊₁>0, there exists a minimum eflection routing that assigns a packet in Tᵢ to dᵢ₊₁.

Proof: Consider a minimum deflection routing R that does not assign a packet from Tᵢ to dᵢ₊₁. Since |Tᵢ|>wᵢ, there must be a packet c in Tᵢ that is deflected. One can assign c to dᵢ₊₁ and deflect one packet c that is already assigned to dᵢ₊₁ in R, thus not exceeding the weight wᵢ₊₁. One obtains a minimum deflection routing R′ that assigns a packet in Tᵢ to dᵢ₊₁.

Note that Lemma 1C and Lemma 2C are independent, implying that the first and second stages of the minimum deflection routing algorithm 130c can be interleaved in any way until both stages are done. Note also that after the second stage is done wᵢ₊₁>0 and |Tᵢ|≦wᵢ. The next lemma provides a justification for the last stage of the minimum deflection routing algorithm 130c.

Lemma 3C: In an adjacent weighted BG₂ graph, if (wᵢ>0 or Sᵢ=0) and (wᵢ₊₁>0 or |Tᵢ|≦wᵢ), then the routing that assigns min(wⱼ,|Tⱼ|) packets in Tⱼ to dⱼ is a minimum deflection routing.

Proof: Consider the routing R that assigns min(wⱼ,|Tⱼ|) packets in Tⱼ to dⱼ (the third stage). The inventors prove that R is a minimum deflection routing. Since wⱼ>0 and Sⱼ=0, no routing can assign any packet in the sets Sᵢ. On the other hand, a minimum deflection routing cannot assign more than min(wⱼ,|Tⱼ|) packets in Tⱼ for which wⱼ₊₁=0, and in general cannot assign more than |Tⱼ| packets in Tⱼ. For all j such that wⱼ₊₁=0, R assigns min(wⱼ,|Tⱼ|) packets in Tⱼ to dⱼ. For all j such that wⱼ₊₁>0, it is known that |Tⱼ|≦wⱼ and hence assigns min(wⱼ,|Tⱼ|)=|Tⱼ| packets in Tⱼ to dⱼ. Therefore, the number of packets in the sets Tᵢ assigned in the routing R is at least equal to the number of packets in the sets Tᵢ that are assigned in a minimum deflection routing. As a result, the total number of packets assigned in R is equal to the total number of packets assigned in a minimum deflection routing, hence R is a minimum deflection routing.

Using the above three lemmas, we can prove the following result:

Theorem 1C: The minimum deflection routing algorithm 130c computes a minimum deflection routing in an adjacent weighted BG₂ graph.

Proof: First the inventors note that after the first and second stages are done, wᵢ>0 and Sᵢ=0, and wᵢ₊₁>0 and |Tⱼ|≦wⱼ for all i=0 . . . |V_{d}|−1. Therefore, one can conclude that starting from the third stage, the minimum deflection routing algorithm 130c computes a minimum deflection routing by Lemma 3, since it assigns min(wⱼ, |Tⱼ|) packets in Tⱼ to dⱼ. By Lemma 1C and Lemma 2C, up to the end of the first and second stages, the minimum deflection routing algorithm 130c makes assignments that are part of a minimum deflection routing. Therefore, the minimum deflection routing algorithm 130c computes a minimum deflection routing in an adjacent weighted BG₂.

The minimum deflection routing algorithm 130c also has a linear time complexity in the RAM model as stated in the following theorem:

Theorem 2C: The time complexity of the minimum deflection routing algorithm 130c is O(|V_{c}|) in the RAM model.

Proof: First note that the representation of FIG. 7 can be obtained in O(|V_{c}|) since |V_{d}|≦2|V_{c}|. In each step of the minimum deflection routing algorithm 130c, one packet is removed from a set of packets. When a packet is removed, a constant time is needed to update the size of a set and the weight of a direction. Checking the conditions in the different stages can also be done in constant time by maintaining information about the different sets Sᵢ and Tᵢ, and updating that information whenever a packet is removed. More precisely, for a specific condition, a list of sets that satisfy the condition can be maintained and updated. As a result, checking a condition would be equivalent to checking whether the list is empty. If each set has pointers to its requested directions and each direction has pointers to its left and right sets of packets, then the work spent on updating the list will be constant after each removal of a packet; this is because the removal of a packet can affect at most two sets: it will decrease the size of the set to which it belongs and the weight of the direction to which it is assigned, which in turn affects the condition involving at most one other set of packets. Therefore, the complexity of the minimum deflection routing algorithm 130c is O(|V_{c}|).

As described above, the three embodiments of the routing strategy 130 can be characterized as either a non-weighted minimum deflection routing algorithm 130a and 130b (first and second embodiments) or a weighted minimum deflection routing algorithm 130c (third embodiment). By definition, a minimum deflection routing algorithm 130a and 130b (first and second embodiments) in the non-weighted BG₂ is also a maximum cardinality matching. The best way for computing the maximum cardinality matching is to run the algorithm in O(m*n^{1/2}) time; therefore, it requires O(n^{1.5}) time to find a minimum deflection routing in a non-weighted BG₂ since m is at most equal to 2n. As such, the algorithm for computing a minimum deflection routing strategy 130a and 130b in a non-weighted BG₂ should run in O(n) time.

In contrast, the problem of computing a minimum deflection routing strategy 130c (third embodiment) in a weighted BG₂ can be cast into a maximum flow problem which can be solved using a standard maximum flow algorithm. However, by imposing a special structure on the weighted BG₂, one is able to obtain an O(n) algorithm for computing a minimum deflection routing in a weighted BG₂. It should be noted that the weighted BG₂ is assigned a weight w for each link 120 and hence each link 120 can accommodate up to w packets.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A bufferless network, comprising:
a plurality of nodes; and
a plurality of links which connect together said nodes, each node executes a routing strategy that deflects a minimum number of packets to unfavorable nodes instead of to favorable nodes that are closer to their final destination nodes, wherein each packet has at most two favorable links to two favorable nodes on which they would like to travel to get to their final destination node.

2. The bufferless network of claim 1, wherein said bufferless network is a synchronous optical burst network.

3. The bufferless network of claim 1, wherein each node is a bufferless node.

4. The bufferless network of claim 1, wherein said routing strategy includes the following steps:
marking all packets as unassigned packets and all links as available links; and
determining if there is a packet not yet assigned to a link;
if yes, determining if there an available link that is requested by only one of the unassigned packets;
if yes, assigning that packet to that available link and marking that packet assigned and that link unavailable and then returning to the first determining step;
if no, determining if anyone of the unassigned packets has a request for one or more available links;
if yes, assigning that packet to anyone of these available links and marking that packet assigned and that link unavailable and then returning to the first determining step; and
if no, deflecting and assigning that packet to any link that is currently available even though that link was not requested by the packet and then marking that packet assigned and that link unavailable and then returning to the first determining step; and
if no, stopping the minimum deflection routing algorithm.

5. The bufferless network of claim 1, wherein said routing strategy includes the following steps:
marking all packets as unassigned packets and all links as available links; and
determining if there is a packet not yet assigned to a link;
if yes, determining if one of the unassigned packets requested only one available link;
if yes, assigning that packet to that available link and marking that packet assigned and that link unavailable and then returning to the first determining step;
if no, determining if one of the unassigned packets has two requests for available links;
if yes, picking one of the available links requested the least by the unassigned packets and assigning that link to a packet requesting that link and marking that packet assigned and that link unavailable and then returning to the first determining step; and
if no, deflecting and assigning a packet to any link that is currently available even though that link was not requested by the packet and then marking that packet assigned and that link unavailable and then returning to the first determining step; and
if no, stopping the minimum deflection routing algorithm.

6. The bufferless network of claim 1, wherein said routing strategy includes the following steps:
where:
each packet requests at most two contiguous directions;
Sᵢ is the set of packets requesting only one link (dᵢ);
Tᵢ is the set of packets requesting two contiguous links (dᵢ and dᵢ₊₁);
wᵢ is the weight of link (dᵢ);
marking all packets as unassigned packets and all links as available links; and
determining if there is a non-empty Sᵢ and if wᵢ>0;
if yes, assigning a packet in Sᵢ to link dᵢ and removing that packet from Sᵢ and decrementing wᵢ by one and returning to the first determining step;
if no, determining if there is a non-empty Tᵢ and if wᵢ is less than a size of Tᵢ and if wᵢ₊₁>0;
if yes, assigning a packet in Tᵢ to link dᵢ₊₁ and removing that packet from Tᵢ and decrementing wᵢ₊₁ by one and returning to the second determining step;
if no, determining if there is a non-empty Tᵢ and if wᵢ>0;
if yes, assigning a packet in Tᵢ to link dᵢ and removing that packet from Tᵢ and decrementing wᵢ by one and returning to the third determining step;
if no, deflecting and assigning all remaining unassigned packets to remaining unassigned links and then stopping the minimum deflection routing algorithm.

7. A method for executing a routing strategy to deflect a minimum number of packets in a bufferless network that includes a plurality of links that connect together a plurality of nodes, said method comprising the step of:
executing, at each node, a routing strategy that deflects a minimum number of packets to unfavorable nodes instead of to favorable nodes that are closer to their final destination nodes, wherein each packet has at most two favorable links to two favorable nodes on which they would like to travel to get to their final destination node.

8. The method of claim 7, wherein said bufferless network is a synchronous optical burst network.

9. The method of claim 7, wherein each node is a bufferless node.

10. The method of claim 7, wherein said step of executing the routing strategy includes the following steps:
marking all packets as unassigned packets and all links as available links; and
determining if there is a packet not yet assigned to a link;
if yes, determining if there is one available link that is requested by only one of the unassigned packets;
if yes, assigning that packet to that available link and marking that packet assigned and that link unavailable and then returning to the first determining step;
if no, determining if anyone of the unassigned packets has a request for one or more available links;
if yes, assigning that packet to anyone of these available links and marking that packet assigned and that link unavailable and then returning to the first determining step; and
if no, deflecting and assigning that packet to any link that is currently available even though that link was not requested by the packet and then marking that packet assigned and that link unavailable and then returning to the first determining step; and
if no, stopping the minimum deflection routing algorithm.

11. The method of claim 7, wherein said step of executing the routing strategy includes the following steps:
marking all packets as unassigned packets and all links as available links; and
determining if there is a packet not yet assigned to a link;
if yes, determining if one of the unassigned packets requested only one available link;
if yes, assigning that packet to that available link and marking that packet assigned and that link unavailable and then returning to the first determining step;
if no, determining if one of the unassigned packets has two requests for available links;
if yes, picking one of the available links requested the least by the unassigned packets and assigning that link to a packet requesting that link and marking that packet assigned and that link unavailable and then returning to the first determining step; and
if no, deflecting and assigning a packet to any link that is currently available even though that link was not requested by the packet and then marking that packet assigned and that link unavailable and then returning to the first determining step; and
if no, stopping the minimum deflection routing algorithm.

12. The method of claim 7, wherein said step of executing the routing strategy includes the following steps:
where:
each packet requests at most two contiguous directions;
Sᵢ is the set of packets requesting only one link (dᵢ);
Tᵢ is the set of packets requesting two contiguous links (dᵢ and dᵢ₊₁);
wᵢ is the weight of link (dᵢ);
marking all packets as unassigned packets and all links as available links; and
determining if there is a non-empty Sᵢ and if wᵢ>0;
if yes, assigning a packet in Sᵢ to link dᵢ and removing that packet from Sᵢ and decrementing wᵢ by one and returning to the first determining step;
if no, determining if there is a non-empty Tᵢ and if wᵢ is less than a size of Tᵢ and if wᵢ₊₁>0;
if yes, assigning a packet in Tᵢ to link dᵢ₊₁ and removing that packet from Tᵢ and decrementing wᵢ₊₁ by one and returning to the second determining step;
if no, determining if there is a non-empty Tᵢ and if wᵢ>0;
if yes, assigning a packet in Tᵢ to link dᵢ and removing that packet from Tᵢ and decrementing wᵢ by one and returning to the third determining step;
if no, deflecting and assigning all remaining unassigned packets to remaining unassigned links and then stopping the minimum deflection routing algorithm.

13. A bufferless network, comprising:
a plurality of nodes; and
a plurality of links that connect said nodes to one another in such a way as to form a topology in which each node executes a minimum deflection routing algorithm that deflects a minimum number of packets to unfavorable nodes instead of to favorable nodes in accordance with the following expression that computes a routing set (R) for all the packets and links:
```
R = φ
while E ≠ φ
    if ∃ (u,v) ∈ E with deg(v) = 1
        R=R ∪ {(u,v)}
    else
        pick any (u,v) ∈ E
        R=R ∪ {(u,v)}
```
remove all edges in E that are adjacent to vertices u or v, where u is a packet and v is a link.

14. The bufferless network of claim 13, wherein said minimum deflection routing algorithm is a non-weighted minimum deflection routing algorithm.

15. The bufferless network of claim 13, wherein said bufferless network is a synchronous optical burst network in which all of the packets in one of the nodes leave at the same time and new packets arrive at that node at that same time.

16. The bufferless network of claim 13, wherein each node is a bufferless node.

17. The bufferless network of claim 13, wherein each packet has at most two favorable links on which they would like to travel to get to their final destination node.

18. A bufferless network, comprising:
a plurality of nodes; and
a plurality of links that connect said nodes to one another in such a way as to form a topology in which each node executes a minimum deflection routing algorithm that deflects a minimum number of packets to unfavorable nodes instead of to favorable nodes in accordance with the following expression that computes a routing set (R) for all the packets and links:
R≠φ
```
while E ≠ φ
    if ∃ (u,v) ∈ E with deg(u) = 1
        R=R ∪ {(u,v)}
    else
        pick any (u,v) ∈ E such that deg(v) is minimum
        R=R ∪ {(u,v)}
```
remove all edges in E that are adjacent to vertices u or v, where u is a packet and v is a link.

19. The bufferless network of claim 18, wherein said minimum deflection routing algorithm is a non-weighted minimum deflection routing algorithm.

20. The bufferless network of claim 18, wherein said bufferless network is a synchronous optical burst network in which all of the packets in one of the nodes leave at the same time and new packets arrive at that node at that same time.

21. The bufferless network of claim 18, wherein each node is a bufferless node.

22. The bufferless network of claim 18, wherein each packet has at most two favorable links on which they would like to travel to get to their final destination node.

23. A bufferless network, comprising:
a plurality of nodes; and
a plurality of links that connect said nodes to one another in such a way as to form a topology in which each node executes a minimum deflection routing algorithm that deflects a minimum number of packets to unfavorable nodes instead of to favorable nodes in accordance with the following expression that computes a routing set (R) for all the packets and all links:
where:
Sᵢ is the set of packets (c) requesting only one link (dᵢ);
Tᵢ is the set of packets requesting two contiguous links (dᵢ and dᵢ₊₁); and
wᵢ is the weight of link (dᵢ);
R=φ
while ∃i such that Sᵢ≠φ and wᵢ>0 (degree 1 assign) pick any packet c ε Sᵢ
Sᵢ=Sᵢ−{c}
wᵢ−wᵢ−1
R=R∪{(c,dᵢ)}
while ∃i such that |Tᵢ|>wᵢ and wᵢ₊₁>0 (right assign) pick any packet c ε Tᵢ
Tᵢ=Tᵢ−{c}
wᵢ₊₁=wᵢ₊₁−1
R−R∪{(c,dᵢ₊₁)}
while ∃i such that Tᵢ≠φ and wᵢ>0 (left assign) pick any packet c ε Tᵢ
Tᵢ=Tᵢ−{c}
wᵢ=wᵢ−1
R=R∪{(c,dᵢ)}

24. The bufferless network of claim 23, wherein said minimum deflection routing algorithm is a weighted minimum deflection routing algorithm.

25. The bufferless network of claim 23, wherein said bufferless network is a synchronous optical burst network in which all of the packets in one of the nodes leave at the same time and new packets arrive at that node at that same time.

26. The bufferless network of claim 23, wherein each node is a bufferless node.

27. The bufferless network of claim 23, wherein each packet has at most two favorable contiguous links on which they would like to travel to get to their final destination node.
